(19) United States
(12) Patent Application Publication
(10) Pub. No.: US 2015/0269272 A1
(43) Pub. Date: Sep. 24, 2015

(54) METHODS, DEVICES, AND APPARATUSES FOR ADJUSTING DISPLAY OF WEBPAGE

(71) Applicant: Xiaomi Inc., Beijing (CN)

(72) Inventors: Zhongyi Du, Beijing (CN); Jinglong Zuo, Beijing (CN); Guoshi Xu, Beijing (CN)

(73) Assignee: Xiaomi Inc.

(21) Appl. No.: 14/658,422

(22) Filed: Mar. 16, 2015

Related U.S. Application Data
(63) Continuation of application No. PCT/CN2014/091198, filed on Nov. 14, 2014.

(30) Foreign Application Priority Data
Mar. 21, 2014 (CN) 201410108833.X

(51) Int. Cl. G06F 17/30; G06F 3/0484; G06F 17/21

(52) U.S. Cl. CPC G06F 17/30905; G06F 17/212; G06F 3/04842; G06F 3/04845

(57) ABSTRACT

A method for a device to adjust display of a webpage is provided. The method includes: receiving a webpage adjusting instruction including coordinates of at least one touch point, wherein the webpage adjusting instruction is generated when a touch operation on the webpage is detected; determining a target content node from one or more content nodes associated with the webpage based on the coordinates of the at least one touch point and a Document Object Model (DOM) tree of the webpage; and causing a center of a display area corresponding to the target content node to be displayed at a center of a screen.

### CROSS-REFERENCE TO RELATED APPLICATION

This application is a continuation application of International Application No, PCT/CN2014/091198, filed Nov. 14, 2014, which is based upon and claims priority to Chinese Patent Application No. 201410108833.X, filed Mar. 21, 2014, the entire contents of all of which are incorporated herein by reference.

### TECHNICAL FIELD

The present disclosure generally relates to the field of computer technology and more particularly, to methods, devices, and apparatuses for adjusting display of a webpage.

### BACKGROUND

With the development of mobile network and the popularity of portable mobile terminals, network activities are frequently carried out by users through the use of smart phones, tablet personal computers (PCs), eBook readers or other electronic equipment. Web browsing is a typical network activity performed by the users through the portable mobile terminals.

As screen sizes of the smart mobile phones, tablet PCs, &Book readers and other electronic equipment are relatively small compared to the screen size of personal computers (PCs), and many webpages in a current network are developed for PCs, portable mobile terminals often need to adjust display of the webpages for the convenience of user browsing. In the conventional technology, portable mobile terminals typically provide a webpage adjusting function that allows users to browse entire contents of the webpage through various gestures, such as a gesture for zooming in the webpage to a suitable size or a drag gesture for moving the webpage.

### SUMMARY

According to a first aspect of the present disclosure, there is provided a method for a device to adjust display of a webpage, comprising: receiving a webpage adjusting instruction including coordinates of at least one touch point, wherein the webpage adjusting instruction is generated when a touch operation on the webpage is detected; determining a target content node from one or more content nodes associated with the webpage based on the coordinates of the at least one touch point and a Document Object Model (DOM) tree of the webpage; and causing a center of a display area corresponding to the target content node to be displayed at a center of a screen.

According to a second aspect of the present disclosure, there is provided a terminal device, comprising: a processor; and a memory for storing instructions executable by the processor. The processor is configured to: receive a webpage adjusting instruction generated including coordinates of at least one touch point, wherein the webpage adjusting instruction is generated when a touch operation on a webpage is detected; determine a target content node from one or more content nodes associated with the webpage based on the coordinates of the at least one touch point and a Document Object Model (DOM) tree of the webpage; and cause a center of a display area corresponding to the target content node to be displayed at a center of a screen.

According to a third aspect of the present disclosure, there is provided a non-transitory computer-readable storage medium having stored therein instructions that, when executed by a processor of a terminal device, cause the terminal device to: receive a webpage adjusting instruction including coordinates of at least one touch point, wherein the webpage adjusting instruction is generated when a touch operation on a webpage is detected; determine a target content node from one or more content nodes associated with the webpage based on the coordinates of the at least one touch point and a Document Object Model (DOM) tree of the webpage; and cause a center of a display area corresponding to the target content node to be displayed at a center of a screen.

It is to be understood that both the foregoing general description and the following detailed description are exemplary rather than limiting the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for adjusting display of a webpage, according to an exemplary embodiment,

FIG. 2 is a flowchart of a method for adjusting display of a webpage, according to an exemplary embodiment.

FIG. 3 is a schematic diagram illustrating a user operation, according to an exemplary embodiment.

FIG. 4 is a schematic diagram illustrating a user operation, according to another exemplary embodiment.

FIG. 5 is a schematic diagram illustrating a user operation, according to another exemplary embodiment.

FIG. 6 is a schematic diagram illustrating an adjusted display of a webpage, according to an exemplary embodiment.

FIG. 7 is a flowchart of a method for adjusting display of a webpage, according to an exemplary embodiment.

FIG. 8 is a block diagram of an apparatus for adjusting display of a webpage, according to an exemplary embodiment.

FIG. 9 is a block diagram of an apparatus for adjusting display of a webpage, according to an exemplary embodiment.

FIG. 10 is a block diagram of a terminal device, according to an exemplary embodiment.

FIG. 11 is a block diagram of a terminal device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The following exemplary embodiments and description thereof intend to illustrate, rather than to limit, the present disclosure. Hereinafter, the present disclosure will be described with reference to the drawings.

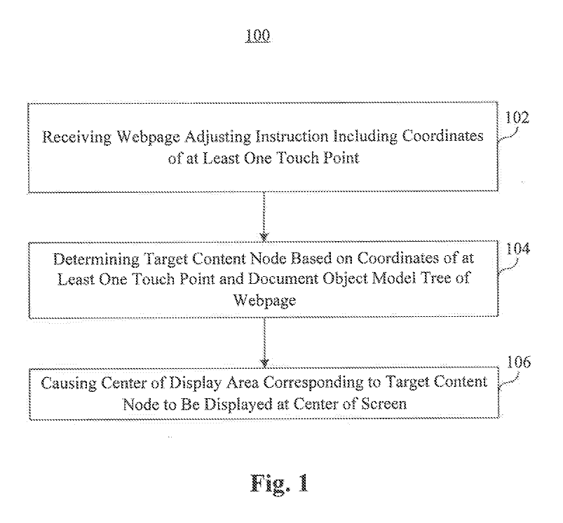

FIG. 1 is a flowchart of a method 100 for adjusting display of a webpage, according to an exemplary embodiment. The method 100 may be performed by a terminal device to adjust display of a webpage. The terminal device may be a smart phone, a tablet computer, an eBook reader, etc. Referring to FIG. 1, the method 100 includes the following steps.

In step 102, the terminal device receives a webpage adjusting instruction including coordinates of at least one touch point. The webpage adjusting instruction may he generated when the terminal device detects a touch operation on a webpage that is being displayed.

In step 104, the terminal device determines a target content node from one or more content nodes of the webpage based on the coordinates of the at least one touch point and a Document Object Model (DOM) tree of the webpage.

For example, the DOM is a cross-platform and language-independent convention for representing and interacting with objects in HTML, XHTML, and XML documents. The nodes of every document are organized in a tree structure, referred to as the DOM tree. Objects in the DOM tree may be addressed and manipulated by using methods on the objects,

In step 106, the terminal device causes a center of a display area corresponding to the target content node to be displayed at a center of a screen.

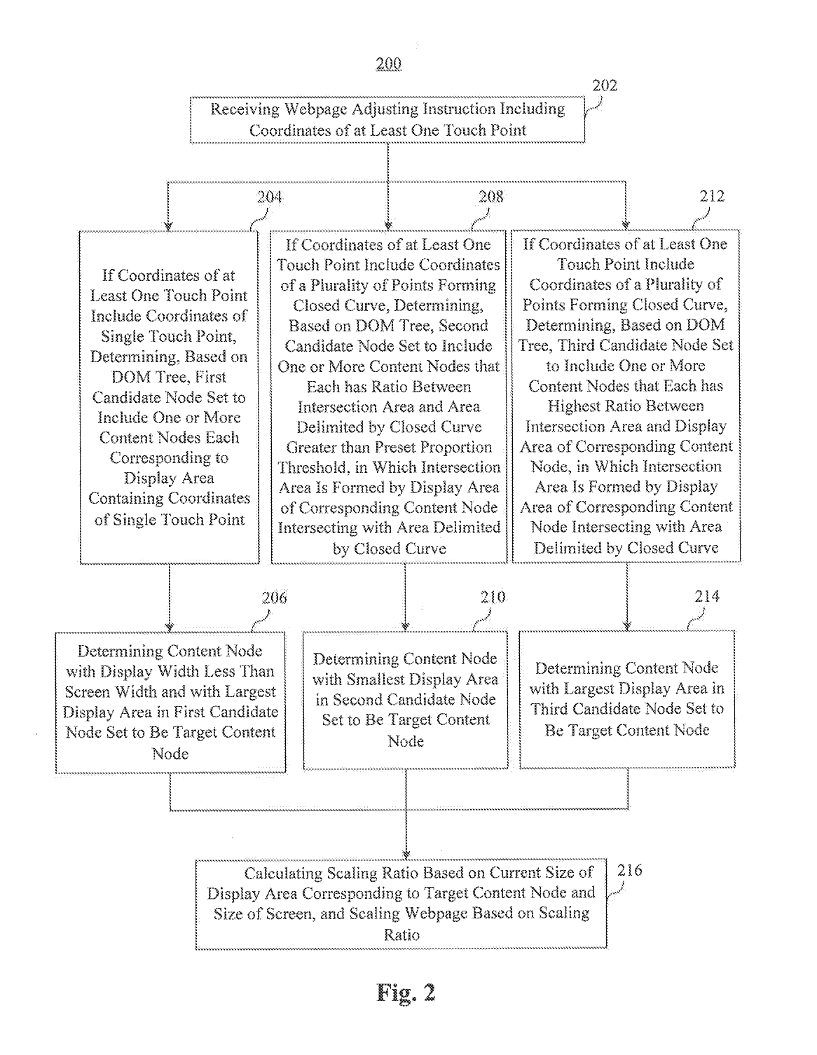

FIG. 2 is a flowchart of a method 200 for adjusting display of a webpage, according to an exemplary embodiment. The method 200 may be performed by a terminal device to adjust a webpage currently displayed. The terminal device may be a smart mobile phone, a tablet computer, an eBook reader, etc. Referring to FIG. 2, the method 200 includes the following steps.

In step 202, the terminal device receives a webpage adjusting instruction including coordinates of at least one touch point.

The webpage adjusting instruction may be generated when the terminal device detects that a user performs a touch operation on the webpage currently displayed, and the touch operation may be a click operation or a slide operation. For example, if the touch operation is the click operation, the webpage adjusting instruction may include coordinates of a touch point corresponding to a click position of the click operation. As another example, if the touch operation is the slide operation and a track of the slide operation forms a closed curve, the webpage adjusting instruction may include coordinates of all touch points on the closed curve.

In step 204, if the coordinates of the at least one touch point include coordinates of a single touch point, the terminal device determines, based on a DOM tree of the webpage, a first candidate node set to include one or more content nodes each corresponding to a display area containing the coordinates of the single touch point.

In some implementations, each visible content node in the DOM tree of the webpage corresponds to one rectangular display area in the screen. A visible content node may further include one or more child nodes, corresponding to one or more small rectangular display areas contained in a large rectangular display area in the screen.

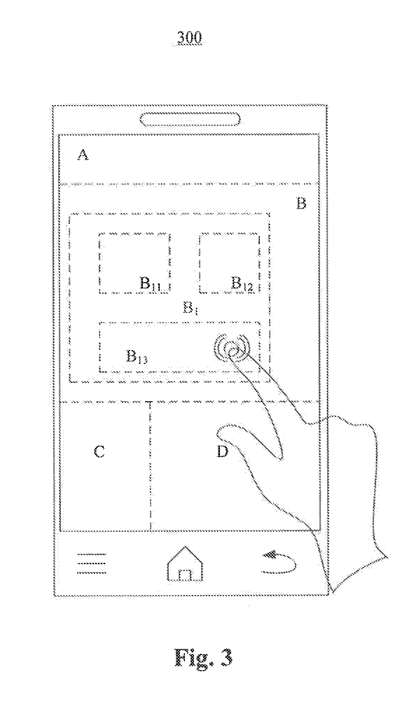

FIG. 3 is a schematic diagram 300 illustrating a user operation, according to an exemplary embodiment. In this example, the terminal device is a smart mobile phone. Referring to FIG. 3, the webpage currently displayed includes four first level visible content nodes corresponding to four rectangular areas A, B, C and D. The first level visible content node corresponding to the rectangular area B contains a second level visible content node corresponding to a rectangular area B1, and the second level visible content node corresponding to the rectangular area B further contains three third level visible content nodes corresponding to three rectangular areas B₁₁, B₁₂ and B₁₃.

As shown in FIG. 3, when the user clicks on the webpage, a webpage adjusting instruction including coordinates of a touch point corresponding to a click position may be generated. In the illustrated embodiment, the smart mobile phone determines that the coordinates of the touch point is located in the rectangular area B₁₃ based on the coordinates of the touch point and the DOM tree. Then, the smart mobile phone may determine that rectangular areas B, B₁, and B₁₃ contain the coordinates of the touch point. The smart mobile phone may determine a first candidate node set that includes content nodes corresponding to the rectangular areas B, B₁, and B₁₃.

In step 206, the terminal device determines a content node with a display width less than a screen width and with a largest display area in the first candidate node set to be the target content node.

For example, in FIG. 3, a width of the rectangular area B is the same as the screen width, and display widths of content nodes corresponding to the rectangular areas B₁ and B₁₃ in the first candidate node set are less than the screen width. As an area of B₁ is larger than an area of B₁₃, the smart mobile phone determines the content node corresponding to the rectangular area B₁ to be the target content node.

In step 208, if the coordinates of the at least one touch point in the received webpage adjusting instruction include coordinates of a plurality of points forming a closed curve, the terminal device determines a second candidate node set based on the DOM tree. The second candidate node set includes one or more content nodes that each has a ratio between an intersection area and an area delimited by the closed curve greater than a preset proportion threshold, in which the intersection area is formed by the display area of the corresponding content node intersecting with the area delimited by the closed curve. For example, the terminal device may identify one or more intersecting content nodes, each of which corresponds to a display area intersecting with an area delimited by the closed curve and forming a corresponding intersecting area. An intersecting content node may be determined to be included in the second candidate node set if a ratio between the corresponding intersection area and the area delimited by the closed curve is greater than a preset proportion threshold.

In some embodiments, the preset proportion threshold may be preset by developers. For example, the preset proportion threshold may be set to 50%, 70%, 80%, or any other proportion number.

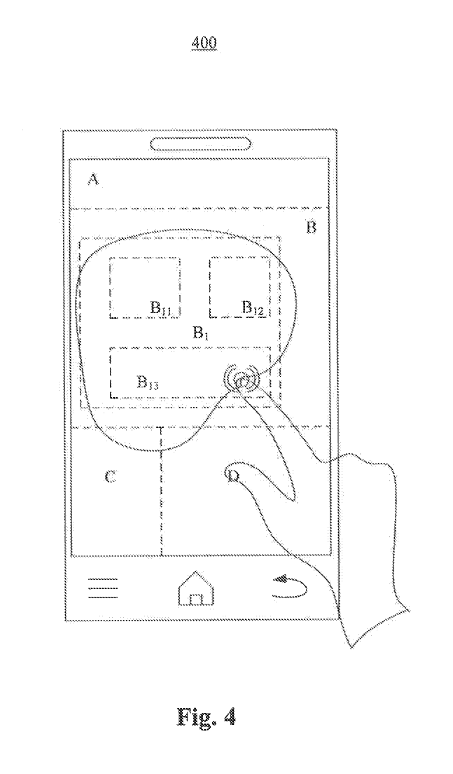

FIG. 4 is a schematic diagram 400 illustrating a user operation, according to another exemplary embodiment. In this example, the terminal device is a smart mobile phone, and the preset proportion threshold is set to 50%. As shown in FIG. 4, display areas corresponding to visible content nodes of the webpage are displayed in the screen of the smart mobile phone initially, and a track of a slide operation carried out by the user forms a closed curve. Accordingly, the webpage adjusting instruction generated when the user carries out the slide operation includes coordinates of a plurality of touch points on the track of the slide operation. In the illustrated embodiment, the smart mobile phone determines that the closed curve covers all display areas except area A (that is, rectangular areas B, B₁, B₁₁, B₁₂, B₁₃, C and D), based on the coordinates of the touch points on the track of the slide operation and the. DOM tree. For each of rectangular areas B and B₁, a ratio between the corresponding intersection area (formed by each of the rectangular area B and B₁ intersecting with the area delimited by the closed curve) and the area delimited by the closed curve is greater than 50%. Thus, the smart mobile phone determines the content nodes corresponding to the rectangular areas B and B₁ as the second candidate node set.

In step 210, the terminal device determines a content node with a smallest display area in the second candidate node set to be the target content node,

For example, in FIG. 4, as the area of B₁ is smaller than the area of B, the smart mobile phone determines the content node corresponding to the rectangular area B₁ to be the target content node.

In step 212, if the coordinates of the at least one touch point include coordinates of a plurality of points forming a closed curve, the terminal device determines a third candidate node set based on the DOM tree. The third candidate node set includes one or more content nodes that each has a highest ratio between an intersection area and the display area of the corresponding content node, in which the intersection area is formed by the display area of the corresponding content node intersecting with the area delimited by the closed curve. For example, the terminal device may identify one or more intersecting content nodes, each of which corresponds to a display area intersecting with the area delimited by the closed curve and forming a corresponding intersecting area. The terminal device may determine that an intersecting content node is in the third candidate node set if a ratio between the corresponding intersection area and the area delimited by the closed curve is one of the highest among the intersecting content nodes.

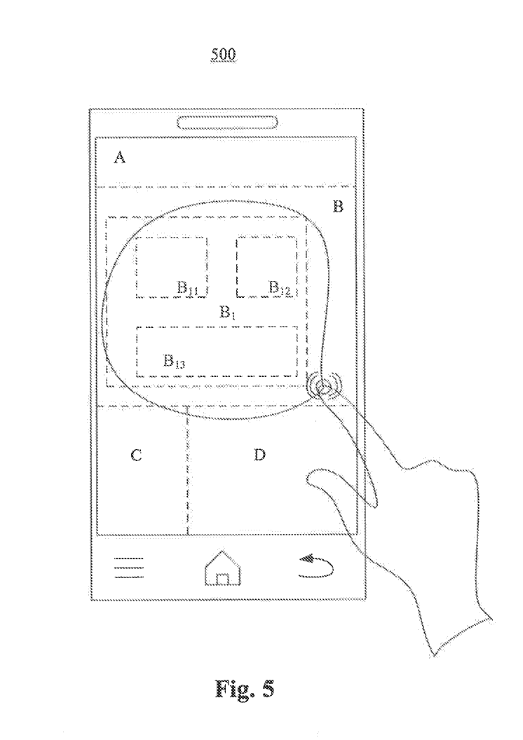

FIG. 5 is a schematic diagram 500 illustrating a user operation, according to another exemplary embodiment. In this example, the terminal device is a smart mobile phone. As shown, In FIG. 5, display areas corresponding to the visible content nodes of the webpage are displayed in the screen of the smart mobile phone initially, and a track of a slide operation carried out by the user forms a closed curve. The webpage adjusting instruction, generated when the user carries out the slide operation includes coordinates of a plurality of touch points on the track of the slide operation. In the illustrated embodiment, the smart mobile phone determines that the closed curve covers all display areas except area A (that is, the rectangular areas B, B₁, B₁₁, B₁₂, B₁₃, C and D), based on coordinates of the touch points on the track of the slide operation and the DOM tree. An intersection area is formed by the rectangular areas B₁₁, B₁₂ and B₁₃ intersecting with the area delimited by the closed curve respectively. As there are three content nodes (corresponding to the rectangular areas B₁₁, B₁₂ and B₁₃, respectively) each with a ratio between an intersection area and the area of the corresponding rectangular area being the highest (100%), the smart mobile phone determines the third candidate node set to include content nodes corresponding to the rectangular areas B₁₁, B₁₂ and B₁₃.

In step 214, the terminal device determines a content node with a largest display area in the third candidate node set to be the target content node.

For example, in FIG. 5, as the area of B₁₃ is larger than both the area of and the area of B₁₂, the smart mobile phone determines the content node corresponding to the rectangular area B₁₃ to be the target content node.

In step 216, the terminal device calculates a scaling ratio based on the size of the display area corresponding to the target content node and the size of the screen, and scales the webpage is based on the scaling ratio.

In some embodiments, the terminal device may preset a preferred ratio of a scaled display area, corresponding to the target content node, to the screen. For instance, the terminal device may preset a preferred ratio of a width of the scaled display area, corresponding to the target content node, to the screen width, or preset a preferred ratio of a height of the scaled display area, corresponding to the target content node, to a height of the screen. The preferred ratio may be set to 80%, 100%, 120% or any other value.

For example, the preferred ratio of the width of the scaled display area corresponding to the target content node to the screen width may be preset to 100%. If a current width of the display area corresponding to the target content node is 5 and the screen width is 10, the scaling ratio will be set to +100%, that is, zooming in by 100%. If the current width of the display area corresponding to the target content node is 20 and the screen width is 10, the scaling ratio will be −50%, that is, zooming out by 50%, such that the ratio of the width of the scaled display area to the screen width will be 100%.

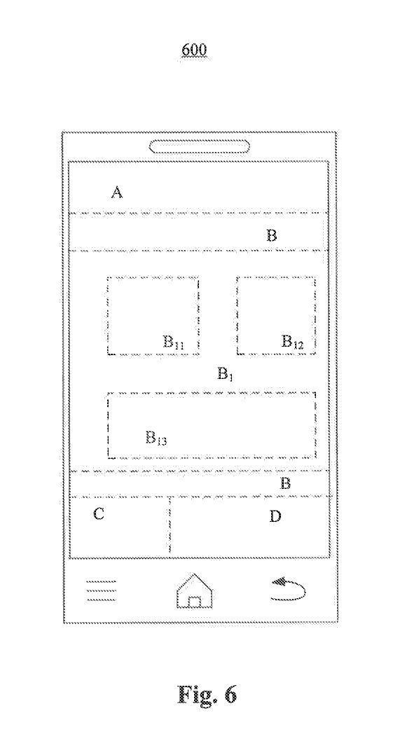

FIG. 6 is a schematic diagram 600 illustrating an adjusted display of a webpage, according to an exemplary embodiment. For example, if the smart mobile phone illustrated in any of FIG. 3-FIG. 5 determines that the target content node is the visible content node corresponding to the rectangular area B₁, a center of the rectangular area B₁ will be adjusted to the center of the screen and the width of the rectangular area B₁ will be adjusted to the screen width based on the calculated scaling ratio, as shown in FIG. 6.

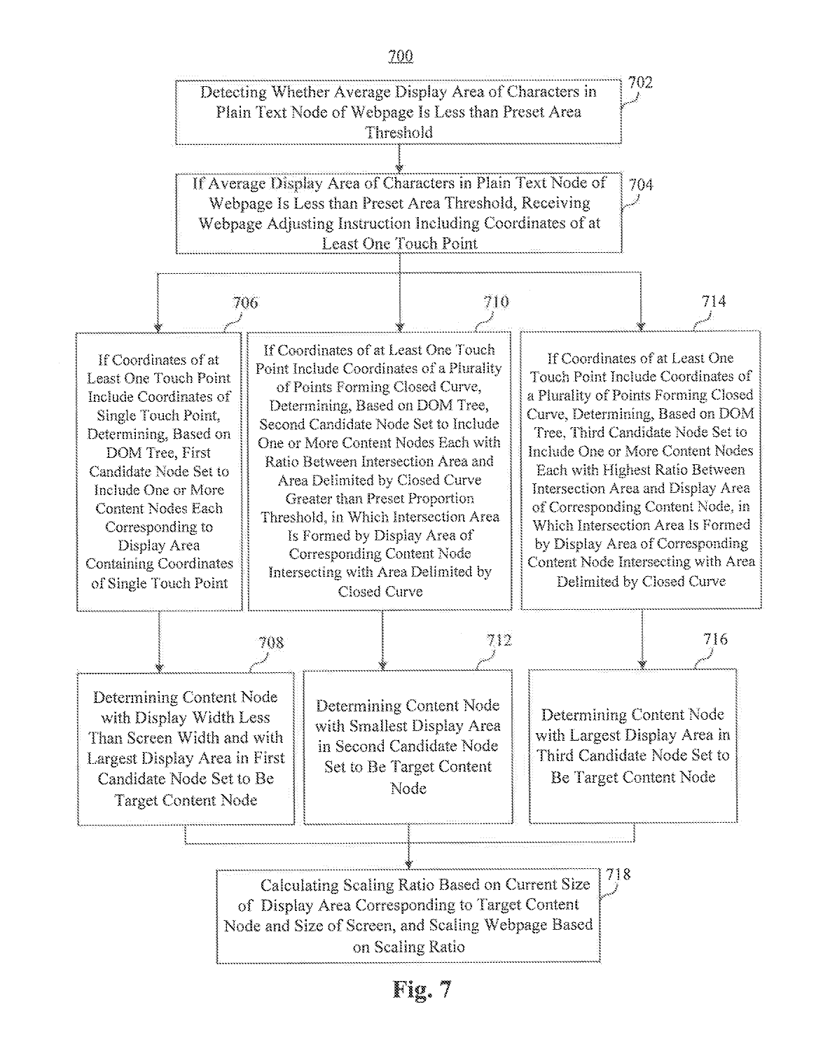

FIG. 7 is a flowchart of a method 700 for adjusting display of a webpage, according to an exemplary embodiment. The method 700 may be performed by a terminal device to adjust display of a webpage. The terminal device may be a smart mobile phone, a tablet computer, an eBook reader, etc. Referring to FIG. 7, the method 700 includes the following steps.

In step 702, the terminal device detects whether an average display area of characters in a plain text node of the webpage is less than a preset area threshold.

As certain processing resources will be occupied and certain electric energy will be consumed when the webpage is scaled and moved, it may not be necessary to scale or move all webpages displayed in a portable terminal device. To save processing resources and electric energy of the terminal device, the terminal device may be configured to receive a webpage adjusting instruction when a webpage needs to be adjusted. Specifically, the terminal device may detect whether the average display area of characters in the plain text node of the webpage currently displayed is less than the preset area threshold. If yes, the display area of the characters may be determined as too small to display, and the webpage currently displayed needs to be adjusted. Otherwise, the webpage currently displayed may be displayed without adjustment.

The preset area threshold may be a fixed value or determined based on a resolution and the size of the screen of the terminal device For example, developers can determine a set of webpages with no need for adjustment through manual annotation, and can calculate an average display area s₁ of characters in a plain text node of each webpage of the set. The terminal device may obtain an average display area s₂ of characters in a plain text node of a current webpage and then determine whether s₂ is less than k*s₁, Where k is a scaling parameter preset by the developers or determined based on the resolution and the size of the screen of the terminal device.

in step 704, if the average display area of characters in the plain text node of the webpage is less than the preset area threshold, the terminal device receives a webpage adjusting instruction including coordinates of at least one touch point.

The webpage adjusting instruction may be generated when it is detected that a user performs a touch operation on the webpage currently displayed, in which the touch operation may be a click operation or a slide operation. For example, if the touch operation is the click operation, the webpage adjusting instruction may include coordinates of a touch point corresponding to a click position of the click operation. If the touch operation is the slide operation and a track of the slide operation is a closed curve, the webpage adjusting instruction may include coordinates of all touch points on the closed curve.

In step 706, if the coordinates of the at least one touch point include coordinates of a single touch point, the terminal device determines, based on a DOM tree of the webpage, a first candidate node set to include one or more content nodes each corresponding to a display area containing the coordinates of the single touch point.

In some implementations, each visible content node in the DOM tree of the webpage corresponds to one rectangular display area in the screen. A visible content node may further include one or more child nodes, which are displayed as one or more small rectangular display areas contained in a large rectangular display area in the screen.

In step 708, the terminal device determines a content node with a display width less than a screen width and with a largest display area in the first candidate node set to be the target content node.

In step 710, if the coordinates of the at least one touch point in the received webpage adjusting instruction include coordinates of a plurality of points forming a closed curve, the terminal device determines a second candidate node set based on the DOM tree. The second candidate node set includes one or more content nodes each with a ratio between an intersection area and an area delimited by the closed curve greater than a preset proportion threshold, in which the intersection area is formed by the display area of the corresponding content node intersecting with the area delimited by the closed curve. For example, the terminal device may identify one or more intersecting content nodes, each of which corresponds to a display area intersecting with the area delimited by the closed curve and forming a corresponding intersecting area. The terminal device may determine that an intersecting content node is in the second candidate node set if a ratio between the corresponding intersection area and the area delimited by the closed curve is greater than a preset proportion threshold.

In step 712, the terminal device determines a content node with a smallest display area in the second candidate node set to be the target content node.

In step 714, if the coordinates of the at least one touch point in the received webpage adjusting instruction include coordinates of a plurality of points forming a closed curve, the terminal device determines a third candidate node set based on the DOM tree. The third candidate node set includes one or more content nodes each with a highest ratio between an intersection area and the display area of the corresponding content node, in which the intersection area is formed by the display area of the corresponding content node intersecting with the area delimited by the closed curve. For example, the terminal device may identify one or more intersecting content nodes, each of which corresponds to a display area intersecting with the area delimited by the closed curve and forming a corresponding intersecting area. The terminal device may determine that an intersecting content node is in the third candidate node set if a ratio between the corresponding intersection area and the area delimited by the closed curve is one of the highest among the one or more intersecting content nodes.

In step 716, the terminal device determines a content node with a largest display area in the third candidate node set to be the target content node.

In step 718, the terminal device calculates a scaling ratio based on a current size of a display area corresponding to the target content node and a size of the screen, and scales the webpage based on the scaling ratio.

In the method 700, the terminal device receives a webpage adjusting instruction including coordinates of the at least one touch point, determines the target content node from content nodes of the webpage based on the coordinates of the at least one touch point and the DOM tree of the webpage, and causes the center of the display area corresponding to the target content node to be displayed at the center of the screen.

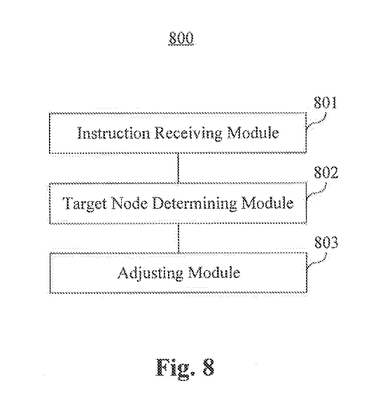

FIG. 8 is a block diagram of an apparatus 800 for adjusting display of a webpage, according to an exemplary embodiment. The apparatus 800 may be included in a terminal device to perform the above described methods. The terminal device may be a smart mobile phone, a tablet computer, an eBook reader, etc. Referring to FIG. 8, the apparatus 800 includes an instruction receiving module 801, a target node determining module 802, and an adjusting module 803.

The instruction receiving module 801 is configured to receive a webpage adjusting instruction including coordinates of at least one touch point. The webpage adjusting instruction may be generated when a touch operation on a currently displayed webpage is detected.

The target node determining module $02 is configured to determine a target content node from one or more content nodes of the webpage based on the coordinates of the at least one touch point and a DOM tree of the webpage.

The adjusting module 803 is configured to cause a center of a display area corresponding to the target content node to be displayed at a center of a screen,

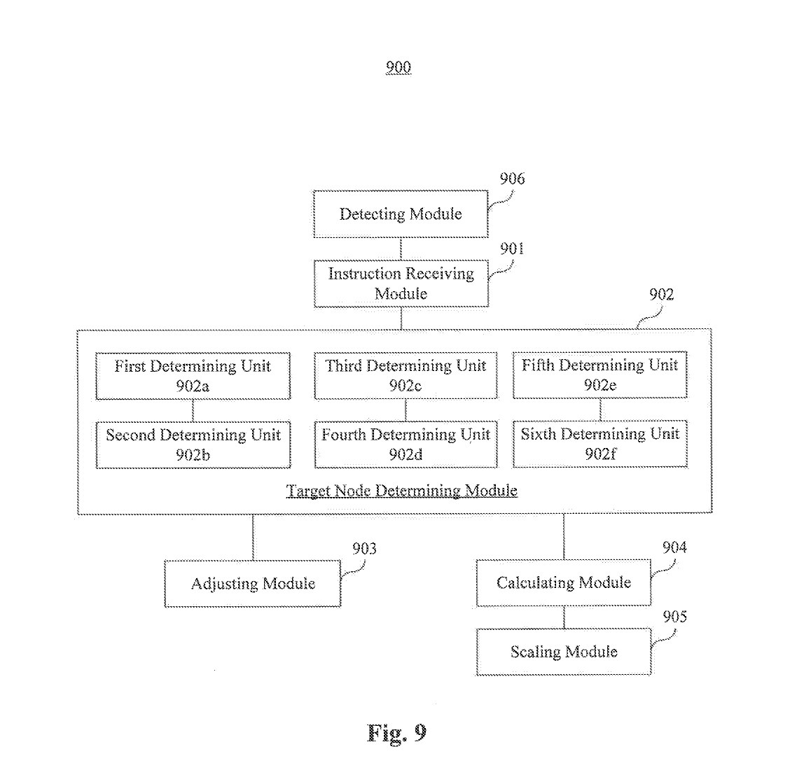

FIG. 9 is a block diagram of an apparatus 900 for adjusting display of a webpage, according to an exemplary embodiment. The apparatus 900 may be included in the terminal device to perform the above described methods. The terminal device may be a smart mobile phone, a tablet computer, an eBook reader, etc. Referring to FIG. 9, the apparatus 900 includes an instruction receiving module 901, a target node determining module 902, and an adjusting module 903,

The instruction receiving module 901 is configured to receive a webpage adjusting instruction generated including coordinates of at least one touch point. The webpage adjusting instruction generated may be generated when a touch operation on a currently displayed webpage is detected.

The target node determining module 902 is configured to determine a target content node from one or more content nodes of the webpage based on the coordinates of the at least one touch point and a DOM tree of the webpage.

The adjusting module 903 is configured to cause a center of a display area corresponding to the target content node to be displayed at a center of a screen.

The apparatus 900 further includes a calculating module 904 and a scaling module 905,

The calculating module 904 is configured to calculate a scaling ratio based on a current size of the display area corresponding to the target content node and a size of the screen.

The scaling module 905 is configured to scale the webpage according to the scaling ratio.

In exemplary embodiments, the target node determining module 902 includes a first determining unit 902a and a second determining unit 902b.

The first determining unit 902a is configured to determine a first candidate node set based on the DOM tree if the coordinates of the at least one touch point include coordinates of a single touch point, in which the first candidate node set includes one or more content nodes each corresponding to a display area containing the coordinates of the single touch point.

The second determining unit 902b is configured to determine a content node with a display width less than a screen width and with a largest display area in the first candidate node set as the target content node.

In exemplary embodiments, the target node determining module 902 further includes a third determining unit 902c and a fourth determining unit 902d.

The third determining unit 902c is configured to determine a second candidate node set based on the DOM tree if the coordinates of the at least one touch point include coordinates of a plurality of points forming a closed curve. The second candidate node set includes one or more content nodes each with a ratio between an intersection area and an area delimited by the closed curve greater than a preset proportion threshold, in which the intersection area is formed by the display area of the corresponding content node intersecting with the area delimited by the closed curve.

The fourth determining unit 902d is configured to determine a content node with a smallest display area in the second candidate node set as the target content node.

In exemplary embodiments, the target node determining module 902 further includes a fifth determining unit 902e and a sixth determining unit 902f.

The fifth determining unit 902e is configured to determine a third candidate node set based on the DOM tree if the coordinates of the at least one touch point include coordinates of a plurality of points forming a closed curve. The third candidate node set includes one or more content nodes each with a highest ratio between an intersection area and an area the display area of the corresponding content node, in which the intersection area is formed by the display area of the corresponding content node intersecting with the area delimited by the closed curve,

The sixth determining unit 902f is configured to determine a content node with a largest display area in the third candidate node set as the target content node,

The apparatus 900 further includes a detecting module 906. The detecting module 906 is configured to detect whether an average display area of characters in a plain text node of the webpage is less than a preset area threshold before a webpage adjusting instruction is received.. The instruction receiving module 901 is configured to perform the step of receiving the webpage adjusting instruction if the detecting module 906 detects that the average display area of characters in the plain text node of the webpage is less than the preset area threshold.

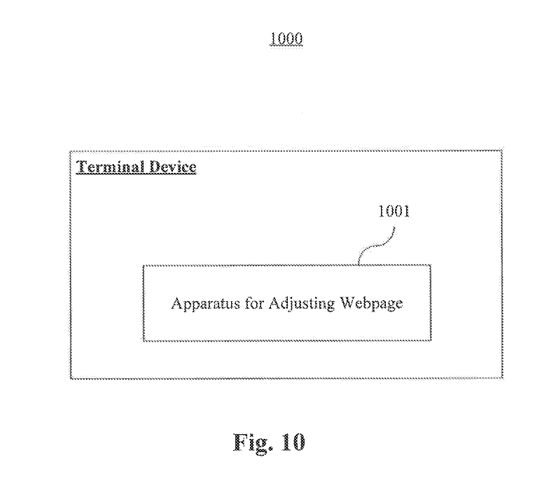

FIG. 10 is a block diagram of a terminal device 1000, according to an exemplary embodiment. The terminal device 1000 may be used to adjust display of a webpage. For example, the terminal device 1000 may be a smart mobile phone, a tablet computer, an eBook reader, and the like.

Referring to FIG. 10, the terminal device 1000 includes an apparatus 1001 for adjusting display of a webpage. The apparatus 1001 may be the same as the apparatus 800 or 900 described in FIG. 8 and FIG. 9 respectively.

The terminal device 1000 allows display area corresponding to the target content node to be adjusted to the center of the screen through a single user operation, thereby simplifying user operation and saving user's time.

Moreover, in the terminal device 1000, a scaling ratio may be calculated based on the current size of the display area corresponding to the target content node and the size of the screen, and the webpage is scaled based on the scaling ratio. In doing so, the display area corresponding to the target content node may be adjusted to a suitable size for browsing, thereby improving user experience and simplifying user operation.

Further, in the terminal device 1000, whether the average display area of characters in the plain text node of the webpage is less than the preset area threshold may be detected before receiving the webpage adjusting instruction. The webpage adjusting instruction may be received if the average display area of characters in the plain text node of the webpage is less than the preset area threshold, thus avoiding adjusting webpages when no adjustment is required and saving the processing resources and electric energy of the terminal device,

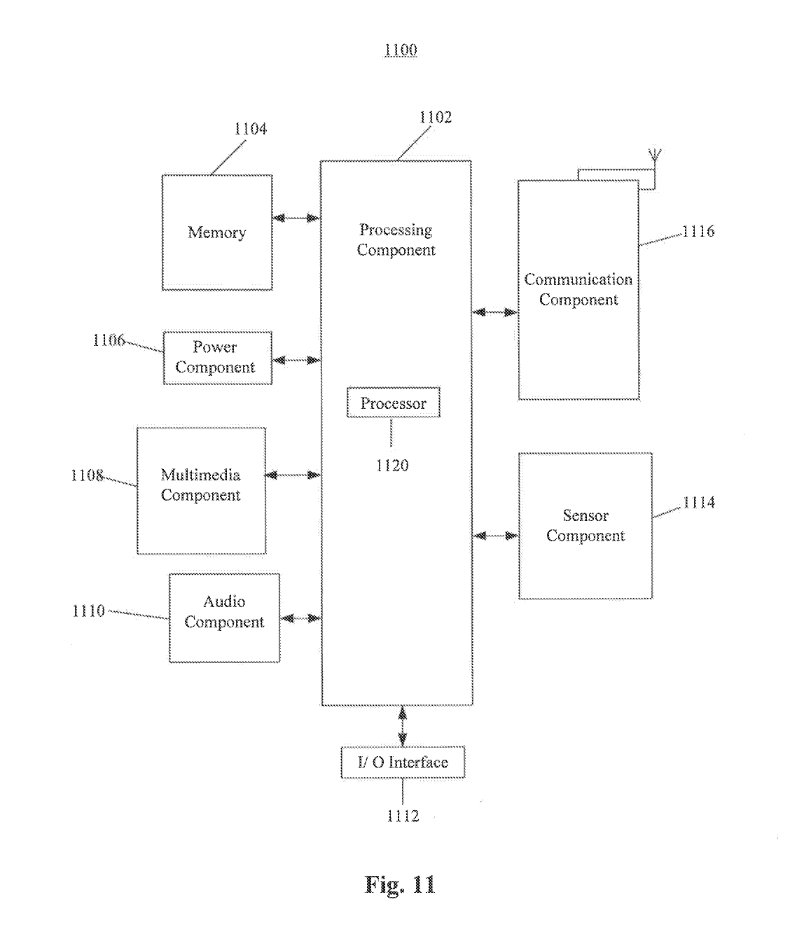

FIG. 11 is a block diagram of a terminal device 1100, according to an exemplary embodiment. For example, the terminal device 1100 may be a mobile phone, a computer, a digital broadcasting terminal, a message sending and receiving device, a game console, a tablet device, a medical equipment, a fitness facility and a personal digital assistant, and the like. The person skilled in the art should appreciate that the structure of the terminal device 1100 as shown in FIG. 11 does not intend to limit the terminal device 1100. The terminal device 1100 may include more or less components or combine some components or other different components,

Referring to FIG. 11, the terminal device 1100 may include one or more of following components: a processing component 11.02, a memory 1104, a power component 1106, a multimedia component 1108, an audio component 1110, an input/output (I/O) interface 1112, a sensor component 1114 and a communication component 1116.

The processing component 1102 typically controls overall operations of the terminal device 1100, such as the operations associated with display, telephone calls, data communications, camera operations, and recording operations. The processing component 1102 may include one or more processors 1120 to execute instructions to perform all or part of the steps in the above described methods. Moreover, the processing component 1102 may include one or more modules which facilitate the interaction between the processing component 1102 and other components. For instance, the processing component 1102 may include a multimedia module to facilitate the interaction between the multimedia component 1108 and the processing component 1102.

The memory 1104 is configured to store various types of data to support the operation of the terminal device 1100. Examples of such data include instructions for any applications or methods operated on the terminal device 1100, contact data, phonebook data, messages, pictures, videos, etc. The memory 1104 is also configured to store programs and modules. The processing component 1102 performs various functions and data processing by operating programs and modules stored in the memory 1104. The memory 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk. The memory 1104 further stores one or more modules, which are configured to be executed by one or more processors 1120 to perform all or part of the steps in the above described methods.

The power component 1106 is configured to provide power to various components of the terminal device 1100. The power component 1106 may include a power management system, one or more power sources, and any other components associated with the generation, management, and distribution of power in the terminal device 1100.

The multimedia component 1108 includes a screen providing an output interface between the terminal device 1100 and the user. In some embodiments, the screen may include a liquid crystal display (LCD) and/or a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1108 includes a front camera and/or a rear camera. The front camera and the rear camera may receive an external multimedia datum while the terminal device 1100 is in an operation mode, such as a photographing mode or a video mode. Each of the front camera and the rear camera may be a fixed optical lens system or have focus and optical zoom capability.

The audio component 1110 is configured to output and/or input audio signals. For example, the audio component 1110 includes a microphone configured to receive an external audio signal when the terminal device 1100 is in an operation mode, such as a call mode, a recording mode, and a voice recognition mode. The received audio signal may be further stored in the memory 1104 or transmitted via the communication component 1116. In some embodiments, the audio component 1110 further includes a speaker to output audio signals.

The I/O interface 1112 provides an interface between the processing component 1102 and peripheral interface modules, such as a keyboard, a click wheel, buttons, and the like. The buttons may include, but are not limited to, a home button, a volume button, a starting button, and a locking button.

The sensor component 1114 includes one or more sensors to provide status assessments of various aspects of the terminal device 1100. For instance, the sensor component 1114 may detect an open/closed status of the terminal device 1100, relative positioning of components, e.g., the display and the keypad, of the terminal device 1100, a change in position of the terminal device 1100 or a component of the terminal device 1100, a presence or absence of user contact with the terminal device 1100, an orientation or an acceleration/deceleration of the terminal device 1100, and a change in temperature of the terminal device 1100. The sensor component 1114 may include a proximity sensor configured to detect the presence of nearby objects without any physical contact. The sensor component 1.114 may also include a light sensor, such as a CMOS or CCD image sensor, for use in imaging applications. In some embodiments, the sensor component 1114 may also include an accelerometer sensor, a gyroscope sensor, a magnetic sensor, a pressure sensor, or a temperature sensor.

The communication component 1116 is configured to facilitate wired or wireless communication between the terminal device 1100 and other devices. The terminal device 1100 can access a wireless network based on a communication standard, such as WiFi, 2G, or 3G, or a combination thereof. In one exemplary embodiment, the communication component 1116 receives a broadcast signal or information from an external broadcast management system via a broadcast channel. In one exemplary embodiment, the communication component 1116 further includes a near field communication (NFC) module to facilitate short-range communications. For example, the NFC module may be implemented based on a radio frequency identification (RFD) technology, an infrared data association (IrDA) technology, an ultra-wideband (UWB) technology, a Bluetooth (BT) technology, and other technologies,

In exemplary embodiments, the terminal device 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1104, executable by the processor 1120 in the terminal device 1100, for performing the above-described methods. For example, the non-transitory computer-readable storage medium may be a ROM, a RAM, a. CD-ROM, a magnetic tape, a floppy disc, an optical data storage device, and the like.

It should be understood by those skilled in the art that the above described methods, devices, modules, and units can each be implemented through hardware, or software, or a combination of hardware and software. One of ordinary skill in the art will also understand that multiple ones of the above described modules/units may be combined as one module/unit, and each of the above described modules/units may be further divided into a plurality of sub-modules/sub-units,

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims,

It should be understood that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a device to adjust display of a webpage, comprising;
receiving a webpage adjusting instruction including coordinates of at least one touch point, wherein the webpage adjusting instruction is generated when a touch operation on the webpage is detected;
determining a target content node from one or more content nodes associated with the webpage based on the coordinates of the at least one touch point and a Document Object Model (DOM) tree of the webpage; and
causing a center of a display area corresponding to the target content node to be displayed at a center of a screen.

2. The method of claim 1, further comprising:
calculating a scaling ratio based on a size of the display area corresponding to the target content node and a size of the screen; and
scaling the webpage based on the scaling ratio.

3. The method of claim 1, wherein determining a target content node comprises:
if the coordinates of the at least one touch point include coordinates of a single touch point, determining a first candidate node set based on the DOM tree, wherein the first candidate node set includes one or more content nodes each corresponding to a display area containing the coordinates of the single touch point; and
determining a content node corresponding to a display width less than a screen width and a largest display area in the first candidate node set to be the target content node.

4. The method of claim 1, wherein determining a target content node comprises:
if the coordinates of the at least one touch point include coordinates of a plurality of points forming a closed curve, determining a second candidate node set based on the DOM tree, wherein determining the second candidate node set comprises:
identifying one or more intersecting content nodes, wherein each of the intersecting content nodes corresponds to a display area intersecting with an area delimited by the closed curve and forming a corresponding intersecting area; and
for each of the one or more intersecting content nodes, determining the intersecting content node to be included in the second candidate node set if a ratio between the corresponding intersection area and the area delimited by the closed curve is greater than a preset proportion threshold; and
determining a content node with a smallest display area in the second candidate node set to be the target content node.

5. The method of claim 1, wherein determining a target content node comprises:
if the coordinates of the at least one touch point include coordinates of a plurality of points forming a closed curve, determining a third candidate node set based on the DOM tree, wherein determining the third candidate node set comprises:
identifying one or more intersecting content nodes, wherein each of the intersecting content nodes corresponds to a display area intersecting with an area delimited by the closed curve and forming a corresponding intersecting area; and
for each of the one or more intersecting content nodes, determining the intersecting content node to be included in the third candidate node set if a ratio between the corresponding intersection area and the display area of the intersecting content node is highest among the one or more intersecting content nodes; and
determining a content node with a largest display area in the third candidate node set to be the target content node.

6. The method of claim 1, further comprising;
detecting whether an average display area of characters in a plain text node of the webpage is less than a preset area threshold; and
if the average display area of characters in the plain text node of the webpage is less than the preset area threshold, performing the receiving of the webpage adjusting instruction.

7. A terminal device, comprising:
a processor; and
a memory for storing instructions executable by the processor;
wherein the processor is configured to:
receive a webpage adjusting instruction generated including coordinates of at least one touch point, wherein the webpage adjusting instruction is generated when a touch operation on a webpage is detected;
determine a target content node from one or more content nodes associated with the webpage based on the coordinates of the at least one touch point and a Document Object Model (DOM) tree of the webpage; and
cause a center of a display area corresponding to the target content node to be displayed at a center of a screen.

8. The terminal device of claim 7, wherein the processor is further configured to:
calculate a scaling ratio based on a size of the display area corresponding to the target content node and a size of the screen; and
scale the webpage based on the scaling ratio.

9. The terminal device of claim 7, wherein when determining the target content node, the processor is configured to;
if the coordinates of the at least one touch point include coordinates of a single touch point, determine a first candidate node set based on the DOM tree, wherein the first candidate node set includes one or more content nodes each corresponding to a display area containing the coordinates of the single touch point; and
determine a content node corresponding to a display width less than a screen width and a largest display area in the first candidate node set to be the target content node.

10. The terminal device of claim 7, wherein when determining the target content node, the processor is configured to.
if the coordinates of the at least one touch point include coordinates of a plurality of points forming a closed curve, determine a second candidate node set based on the DOM tree, wherein determining the second candidate node set comprises:
identifying one or more intersecting content nodes, wherein each of the intersecting content nodes corresponds to a display area intersecting with an area delimited by the dosed curve and forming a corresponding intersecting area; and
for each of the one or more intersecting content nodes, determining the intersecting content node to be included in the second candidate node set if a ratio between the corresponding intersection area and the area delimited by the closed curve is greater a preset proportion threshold; and
determine a content node with a smallest display area in the second candidate node set as the target content node.

11. The terminal device of claim 7, wherein when determining the target content node, the processor is configured to:
if the coordinates of the at least one touch point include coordinates of a plurality of points forming a closed curve, determine a third candidate node set based on the DOM tree, wherein determining the third candidate node set comprises:
identifying one or more intersecting content nodes, wherein each of the intersecting content nodes corresponds to a display area intersecting with an area delimited by the closed curve and forming a corresponding intersecting area; and
for each of the one or more intersecting content nodes, determining the intersecting content node to he included in the third candidate node set if a ratio between the corresponding intersection area and the display area of the intersecting content node is highest among the one or more intersecting content nodes; and
determine a content node with a largest display area in the third candidate node set to be the target content node.

12. The terminal device of claim 7, wherein the processor is further configured to:
detect whether an average display area of characters in a plain text node of the webpage is less than a preset area threshold; and
if the average display area of characters in the plain text node of the webpage is less than the preset area threshold, perform the receiving of the webpage adjusting instruction.

13. A non-transitory computer-readable storage medium having stored therein instructions that, when executed by a processor of a terminal device, cause the terminal device to:
receive a webpage adjusting instruction including coordinates of at least one touch point, wherein the webpage adjusting instruction is generated when a touch operation on a webpage is detected;
determine a target content node from one or more content nodes associated with the webpage based on the coordinates of the at least one touch point and a Document Object Model (DOM) tree of the webpage; and
cause a center of a display area corresponding to the target content node to be displayed at a center of a screen.

14. The non-transitory computer-readable storage medium of claim 13, wherein the instructions when executed by the processor of the terminal device, further cause the terminal device to:
calculate a scaling ratio based on a size of the display area corresponding to the target content node and a size of the screen; and
scale the webpage based on the scaling ratio.

15. The non-transitory computer-readable storage medium of claim 13, wherein the instructions, when executed by the processor of the terminal device, further cause the terminal device to:
if the coordinates of the at least one touch point include coordinates of a single touch point, determine a first candidate node set based on the DOM tree, wherein the first candidate node set includes one or more content nodes each corresponding to a display area containing the coordinates of the single touch point; and
determine a content node corresponding to a display width less than a screen width and a largest display area in the first candidate node set to be the target content node.

16. The non-transitory computer-readable storage medium of claim 13, wherein the instructions, when executed by the processor of the terminal device, further cause the terminal device to:
if the coordinates of the at least one touch point include coordinates of a plurality of points forming a closed curve, determine a second candidate node set based on the DOM tree, wherein determining the second candidate node set comprises:
identifying one or more intersecting content nodes, wherein each of the intersecting content nodes corresponds to a display area intersecting with an area delimited by the closed curve and forming a corresponding intersecting area; and
for each of the one or more intersecting content nodes, determining the intersecting content node to be included in the second candidate node set if a ratio between the corresponding intersection area and the area delimited by the closed curve is greater than a preset proportion threshold; and
determine a content node with a smallest display area in the second candidate node set to be the target content node.

17. The non-transitory computer-readable storage medium of claim 13, wherein the instructions, when executed by the processor of the terminal device, further cause the terminal device to:
if the coordinates of the at least one touch point include coordinates of a plurality of points forming a closed curve, determine a third candidate node set based on the DOM tree, wherein determining the third candidate node set comprises:
identifying one or more intersecting content nodes, wherein each of the intersecting content nodes corresponds to a display area intersecting with an area delimited by the closed curve and forming a corresponding intersecting area; and
for each of the one or more intersecting content nodes, determining the intersecting content node to be included in the third candidate node set if a ratio between the corresponding intersection area and the display area of the intersecting content node is highest among the one or more intersecting content nodes; and
determine a content node with a largest display area in the third candidate node set to be the target content node.

18. The non-transitory computer-readable storage medium of claim 13, wherein the instructions, when executed by the processor of the terminal device, further cause the terminal device to:
detect whether an average display area of characters in a plain text node of the webpage is less than a preset area threshold; and
if the average display area of characters in the plain text node of the webpage is less than the preset area threshold, perform the receiving of the webpage adjusting instruction.
